(19) United States
(12) Patent Application Publication
(10) Pub. No.: US 2015/0356238 A1
(43) Pub. Date: Dec. 10, 2015

(54) Scoring the Deviation of an Individual with High Dimensionality from a First Population

(71) Applicants: Nandini Sen, Palo Alto, CA (US); Adrish Sen, Palo Alto, CA (US); Gourab Mukherjee, Los Angeles, CA (US); Ann M. Arvin, Menlo Park, CA (US)

(72) Inventors: Nandini Sen, Palo Alto, CA (US); Adrish Sen, Palo Alto, CA (US); Gourab Mukherjee, Los Angeles, CA (US); Ann M. Arvin, Menlo Park, CA (US)

(73) Assignee: The Board of Trustees of the Leland Stanford Junior University, Palo Alto, CA (US)

(21) Appl. No.: 14/731,368

(22) Filed: Jun. 4, 2015

Related U.S. Application Data
(60) Provisional application No. 62/009,143, filed on Jun. 6, 2014.

(51) Int. Cl. G06F 19/18

(52) U.S. Cl. CPC G06F 19/18

(57) ABSTRACT

Techniques for scoring deviations of individuals from a population include obtaining profile data for each individual in a first population and from a subject drawn from a second population. The profile data indicates values for each of multiple parameters. Within the first population, a first neighbor and a second neighbor are determined, different from the subject and each other. A first distance of a vector distance metric between the subject and the first neighbor is less than a distance between the subject and any other individual of the first population. A second distance between the first neighbor and the second neighbor is less than a distance between the first neighbor and any other individual of the first population. A deviation of the subject from the first population is determined based on a ratio of the first distance divided by the second distance and presented on a display device.

### CROSS-REFERENCE TO RELATED APPLICATIONS

This application claims benefit of Provisional Appln. 62/009,143, filed 6 Jun. 2014, the entire contents of which are hereby incorporated by reference as if fully set forth herein, under 35 U.S.C. §119(e).

### STATEMENT OF GOVERNMENT INTEREST

This invention was made with government support under Contract No. AI20459 awarded by the National Institutes of Health. The government has certain rights in the invention.

### BACKGROUND OF THE INVENTION

Recent advances in cytometry, microfluidics, and high throughput sequencing allow high-dimensional datasets (including about ten dimensions and greater) to be collected in great numbers. The high dimensionality arises from a large number of parameters for which measurements can be obtained for each individual entity. For example, a biological cell can be characterized by the amount of each of hundreds of proteins or ribonucleic acid (RNA) molecules expressed by that individual cell. Modern experimental procedures can obtain simultaneous measurements of about ten to about 50 such parameters at one time. Thus the state of an indicial cell is represented by a vector with about ten to about 50 values corresponding to amounts of the corresponding ten to 50 parameters. Hundreds to hundreds of thousands of such cells can be measured in each experiment.

However, methods to analyze such large volumes of high-dimensional data are currently not completely satisfactory and rely on reducing data complexity in order to be practical and feasible in terms of computational and time demands. Reduced data complexity is typically accomplished by relying on averaging or reducing the overall dimensionality of the measured parameter space.

### SUMMARY

Techniques are provided to analyze multiple datasets consisting of large numbers of individual samples, where several parameters have been measured to characterize each sample. Techniques are further provided to calculate with statistical confidence the distances (based on all such measured parameters) both between samples within a dataset, and between samples across multiple datasets. Thus, techniques are provided for scoring the deviation from a first population of one or more individuals with high dimensionality.

In a first set of embodiments, a method includes collecting first population data comprising individual profile data for each individual in a first population comprising a first plurality of individuals. The individual profile data indicates values for each parameter of a plurality of parameters. The method also includes determining the individual profile data for a subject drawn from a second population comprising a second plurality of individuals. The method also includes determining, within the first population, a first neighbor for the subject and a second neighbor for the subject, both different from the subject. The second neighbor is different from the first neighbor. A first value of a vector distance metric between the individual profile data for the subject and the individual profile data for the first neighbor is less than a value of the vector distance metric between the individual profile data for the subject and the individual profile data for any other individual of the first population. A second value of the vector distance metric between the individual profile data for the first neighbor and the individual profile data for the second neighbor is less than a value of the vector distance metric between the individual profile data for the first neighbor and the individual profile data for any other individual of the first population. The method includes determining a deviation of the subject from the first population based on a ratio of the first value of the vector distance metric divided by the second value of the vector distance metric.

In some embodiments of the first set, the vector distance metric is a weighted vector distance metric, wherein a difference between values for two individuals of each parameter of the plurality of parameters is multiplied by a weight specific to that parameter. In some of these embodiments, the method includes determining a plurality of principal components of the individual profile data for the first population or the second population; and, the weight specific to each parameter is based on a magnitude for that parameter in a selected principal component of the plurality of principal components. In other of these embodiments, each of the first population and the second population is a population of biological cells. In such embodiments, each parameter of the plurality of parameters represents expression of a corresponding function or molecule type by an individual cell of the corresponding population of biological cells or expressed in bulk by the corresponding population of biological cells. In such embodiments of this set, the weight specific to each parameter is based on a GeneCards Inferred Functionality Score (GIFtS) for the corresponding function or molecule, or based on a number of interacting partners for the corresponding function or molecule, or based on some combination.

In some embodiments of the first set, the method includes determining for each other individual of the second plurality of individuals, a corresponding deviation from the first population based on a ratio of the corresponding first value of the vector distance metric divided by the corresponding second value of the vector distance metric. In some of these embodiments, the second population is characterized by a frequency of occurrence in a plurality of deviation bins or by an average of the corresponding deviations or some combination. In some of these embodiments, the individuals of the second population are sorted (e.g., ranked) by the corresponding deviations.

In other sets of embodiments, a computer-readable medium or apparatus or systems is configured to cause at least one apparatus to perform one or more steps of one of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 is a diagram that illustrates example components of a deviation score for individuals having high-dimensionality for deviations from a first population, according to one embodiment;

FIG. 2A through FIG. 2D are graphs that illustrate example uses of deviation scores of one or more individuals from the first population, according to various embodiments;

FIG. 3 is a graph that illustrates example individuals in the first population and two principal components that explain a large fraction of the variance, used as weights in some embodiments;

FIG. 4 is a flow chart that illustrates an example method for scoring the deviations of one or more individuals in one or more populations from a first population, according to various embodiments;

FIG. 5 is a diagram that illustrates a viral infection that causes T cells to migrate to a skin site, investigated according to one embodiment;

FIG. 6 is a diagram that illustrates populations of T cells among which the deviations of individuals are scored, according to one embodiment;

FIG. 7A is a graph that illustrates three populations of T cells mapped relative to three principal components, according to an embodiment;

FIG. 7B is a graph that illustrates three populations of T cells and a population of virally infected T cells mapped relative to the three principal components, according to an embodiment;

FIG. 8 is a graph that illustrates a deviation score of infected cells from uninfected cells, supporting remodeling of T cells by the virus, according to an embodiment;

FIG. 9 is a diagram that illustrates a model of disease progression inferred from the score of deviations of individuals of high dimensionality, according to an embodiment;

FIG. 10 is a block diagram that illustrates a computer system upon which an embodiment of the invention may be implemented; and

FIG. 11 is a block diagram that illustrates a chip set upon which an embodiment of the invention may be implemented.

### DETAILED DESCRIPTION

Techniques are described for scoring deviations of one or more individuals of high dimensionality from a population, and using those scores. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Some embodiments of the invention are described below in the context of individual cells characterized by a set of cell membrane receptors, or intracellular expressed molecules, and using deviation scores to determine whether virally infected cells are a sub-population of an uninfected population or a new population of cells, e.g., due to reprogramming of T cells. However, the invention is not limited to this context. In other embodiments, the individuals are any entities represented by high-dimensionality, such as persons characterized by age, gender, health status, income level, asset level, education level, zip code, industry of employment, number of children, marital status, geography. The deviations are scored to determine any differences between individuals, such as members of various social networks, or for any of several purposes, such as ranking individuals in a population, or determining whether one treatment or process is more effective than another.

### 1. Overview

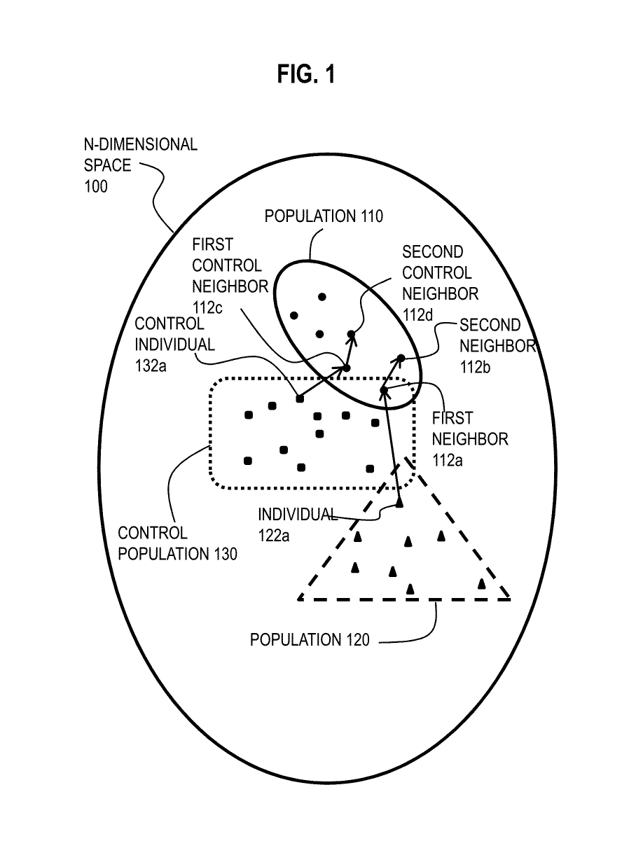

FIG. 1 is a diagram that illustrates example components of a deviation score for individuals having high-dimensionality for deviations from a first population, according to one embodiment. The diagram depicts N-dimensional space 100, such as all possible cells expressing any combination of values of N different proteins. Each point in the N-dimensional space represents a set of N particular values corresponding to the N different parameters (e.g., expression levels of N different proteins in or on a cell). An individual point is represented by individual profile data, wherein the individual profile data indicates values for each parameter of the N parameters. The points can be assigned to one or more populations, such as a first population of healthy cells or a second population of diseased cells. The division of points into populations can be done in any fashion, including a priori, e.g., based on attributes of a sample from which the points are drawn (e.g., cells in samples from patients previously determined to be normal or to be suffering from a disease), manually or automatically, or a posteriori, e.g., based on cluster analysis, spanning tree analysis, or principal component analysis, or some combination, after one or more samples have been collected.

For purposes of illustration, it is assumed that the points in N-dimensional space 100 have been divided into three different populations: a first population 110 of points represented as solid circles, a second population 120 of points represented as solid triangles, and a control population 130 of points represented as solid curved rectangles. For example, the first population represents cells found in a sample from a patient with a disease; the second population 120 represents cells found in a sample from a patient with the same disease and undergoing a proposed treatment; and the control population 130 represents cells found in a sample from a patient with the same disease and undergoing a standard treatment. In such circumstances, it is often asked if there is a significant difference between the individuals in the various populations. While several approaches have been used for points with low dimensionality N, these approaches often require simplifying or reducing the dimensionality for individual points of high-dimensionality N. Traditional dimension reduction techniques like principal component analysis are inconsistent as dimension size increases (see Theorem 1 in Johnstone, Iain M., and Arthur Yu Lu, “On consistency and sparsity for principal components analysis in high dimensions,” Journal of the American Statistical Association 104:486, 2009) and need modifications even in moderate dimensions (greater than about 10).

In a proposed approach, a measure (also called herein a “score”) for a deviation of an individual from a population is based on a ratio of a distance to the individual's nearest neighbor (first neighbor) in that population divided by a distance from that nearest neighbor to the nearest neighbor's nearest neighbor (second neighbor) in that population. The individual can be originally in the population or originally outside the population, e.g., in a different population.

This approach is illustrated twice in FIG. 1. In a first example, the deviation of individual 122a of population 120 from population 110 is based on a ratio of a first distance divided by a second distance. The first distance is the distance from individual 122a to its first neighbor 112a in population 110. The second distance is the distance from the first neighbor 112a to a second neighbor 112b, which is the nearest point in population 110 to the first neighbor 112a. A value significantly greater than one indicates the individual 122a is likely in a different population and gives a deviation score for how far the individual 122a is outside the population 110.

Similarly, the deviation of control individual 132a of control population 130 from population 110 is based on a ratio of a first distance divided by a second distance. The first distance is the distance from control individual 132a to its first neighbor 112c in population 110. The second distance is the distance from the first neighbor 112c to a second neighbor 112d, which is the nearest point in population 110 to the first neighbor 112c. A value significantly greater than one indicates the control individual 132a is likely in a different population and gives a deviation score for how far the control individual 132a is outside the population 110.

Any distance measure may be used in various embodiments. The distance between two N-dimensional arrays is well known and is routinely computed using a variety of metrics. In various embodiments, the differences between corresponding dimensions of the two points are determined. The Chebychev distance, designated l₀, is the largest absolute value of the N differences. Among the standard higher order vector distances {lₚ:p >0}, the popular choices are the Euclidean distance l₂ which is the square root of the sum of the squared values of the N differences and the l₁ distance which is the sum of absolute values of the differences in the separate dimensions. The Hamming distance is also used, particularly for discretely quantized expression values. In some embodiments, a weighted distance is used, where each of the N differences is multiplied by a weighting factor specific to the corresponding dimension (parameter). Any method can be used to determine the weights. In some example embodiments, described below, the weights are related to the relative importance of each parameter, for example in defining principal components on one or more populations, or for functions in the system represented by each individual, e.g., the importance to a cell function, such as ion exchange, metabolism, reproduction or any other function of interest.

The approach using the ratio of these distances offers several advantages. The distance ratio provides quantified comparison between two populations (e.g., samples), each containing a large number of entities (e.g., single cells) where each entity is characterized for several parameters resulting in multidimensional parameter space datasets. The ratio provides cardinality, so can be used to compare groups that differ in the number of subjects. Furthermore, this approach overcomes the problems faced when comparing changes between groups that are represented in different numbers. Even further, the approach is computationally economical, e.g., not every point in the first population need be evaluated, only the nearest neighbors.

In some embodiments, the techniques are used in the context of calculating distances between social entities (“humans”) in social networking datasets to determine if 2 persons are significantly similar to each other, as described in more detail below, in an example embodiment

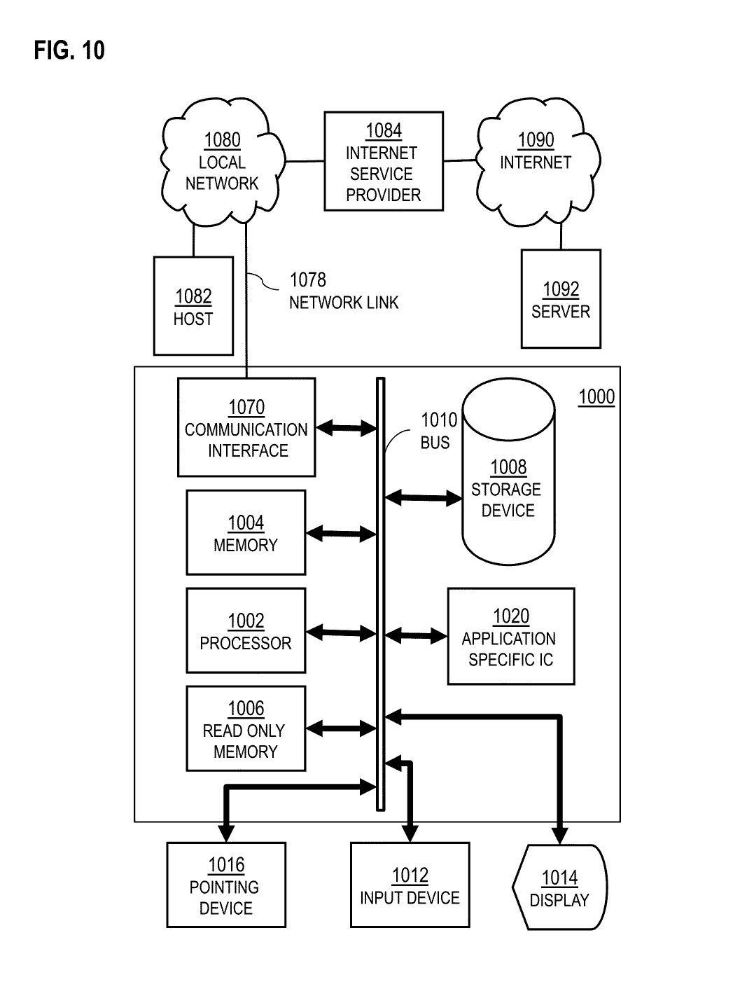

In various embodiments, the ratio is used directly or as a component in a combined score with other attributes. There are multiple uses to which such a score can be put. In one use, the temporal evolution one or more individuals can be monitored by a temporal change in the score. In some embodiments, the average score or standard deviations of the scores or both, for all the individuals in a second or control populations, are used to determine the significance of the difference from the first population or from each other. In some embodiments, the individuals in a second population are ranked or sorted based on their scores. In some embodiments, the distribution of scores is used to classify the population. In each of these cases, the results based on the deviation are presented on a display device, such as display 1014 depicted in FIG. 10. In various embodiments, the results are used to operate on one or more members of one or more of the populations, e.g., to change the treatment of patients whose cells fall into population 110 to use the treatment applied to population 120.

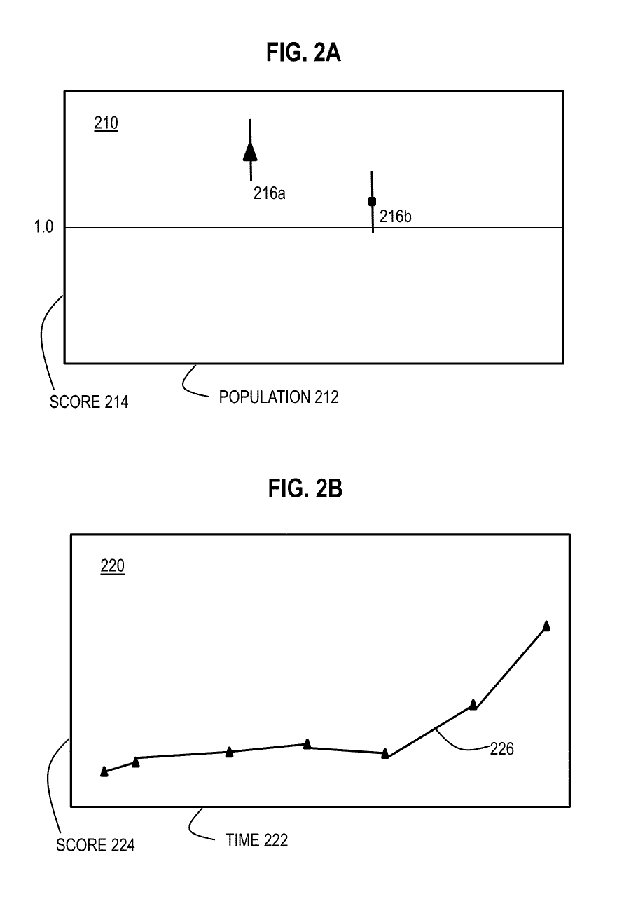

FIG. 2A through FIG. 2D are graphs that illustrate example uses of deviation scores of one or more individuals from the first population, according to various embodiments. FIG. 2A is a graph 210 that illustrates the example score of a population of individuals. The horizontal axis 212 indicates population identifier; and the vertical axis indicates score 214 in arbitrary units with a value of 1.0 indicated by a horizontal line. If the ratio is used directly, the value of 1.0 separates individuals more distant than average from the first population above the line from individuals within the first population, at and below the line. The mean and standard deviation of the population is indicated by a point and vertical bar. For example, it is assumed for purposes of illustration that the average score of the population 120 is given by the center of the solid triangle at point 216a and its standard deviation by the vertical bar. This population shows a significant deviation from the first population. Similarly, it is assumed for purposes of illustration that the average score of the control population 130 is given by the center of the solid rounded rectangle at point 216b and its standard deviation by the vertical bar. This population shows a less significant deviation from the first population. The second and control populations can also be compared to each other using the same scores, by comparing the points 216a and 216b.

FIG. 2B is a graph 220 that illustrates example temporal evolution of one or more individuals in a population. The horizontal axis 222 indicates time in arbitrary units; and, the vertical axis indicates score 224 in arbitrary units. If an individual can be measured at different times, then trace 226 represents the evolution of that individual. If, instead, a population of individuals is measured at successive times, e.g., based on samples taken at successive times after exposure to a disease, or after onset of treatment, then trace 226 represents the evolution of the average of the population.

FIG. 2C is a graph 230 that illustrates example ranking of individuals in a population. The horizontal axis indicates order number in increments of one; and, the vertical axis indicates score 234 in arbitrary units. Each member of population 120 is sorted by its score in order from largest value to smallest value.

FIG. 2D is a graph 240 that illustrates example frequency distribution (histogram) of scores in a population, such as population 120. The horizontal axis 242 indicates score in arbitrary units, arranged in bins, with the value of 1.0 marked. The vertical axis 244 indicates frequency, the number of occurrences of scores within that score bin, in arbitrary units. The histogram of the second population 120 is represented by trace 226a; and, the histogram of the control population 130 is represented by trace 226b. The differences in the two populations are evident as different shaped traces. Other populations can be categorized or classified as more like population 120 or control population 130 based on similarities to these traces.

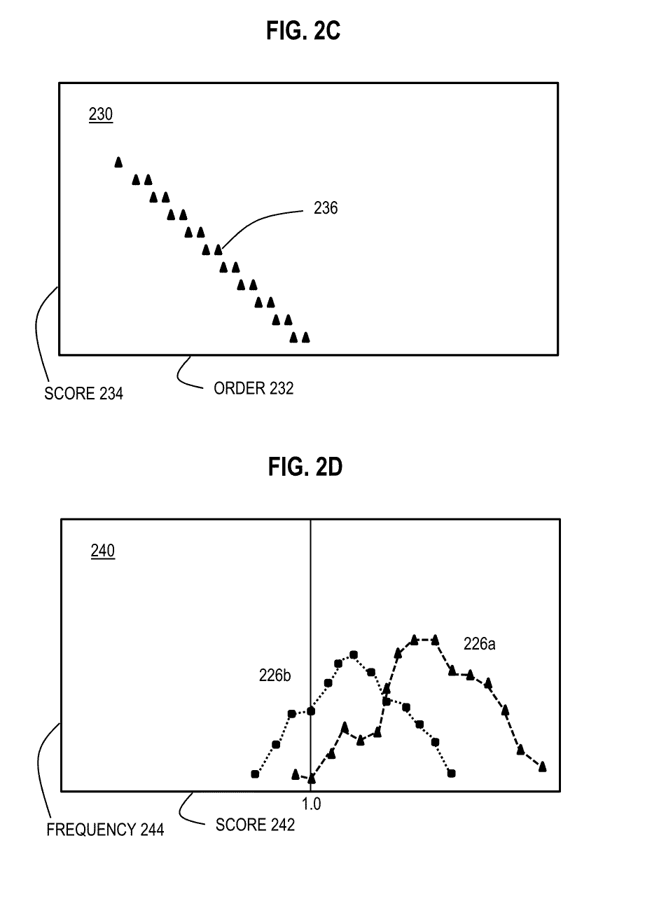

FIG. 3 is a graph 300 that illustrates example individuals in the first population and two principal components that explain a large fraction of the variance, used as weights in some embodiments. The horizontal axis 312 indicates each of N different parameters used as the N dimensions representing each individual. The vertical axis 31 indicates values in arbitrary units, e.g., scaled to have average of zero and variance of one. Traces 316 indicate three individuals of the population, such as first population 110. Using principal components analysis (PCA), well known in the art, the relative variability of each parameter is characterized. Each individual trace is efficiently represented by a linear combination of the principal components and an average value of each of the N dimensions (parameters). Most of the variance is accounted for by the first few principal components; so using just the first few principal components, most individuals are represented with high accuracy. In graph 300, trace 318a illustrates one example principal component, and trace 318ba illustrates one example different principal component. In some embodiments, the weights given to each dimension (parameter) in the distance computation is based on the amplitude of one or more principal components, e.g., principal component 318a, or an average of principal component 318a and principal component 318b.

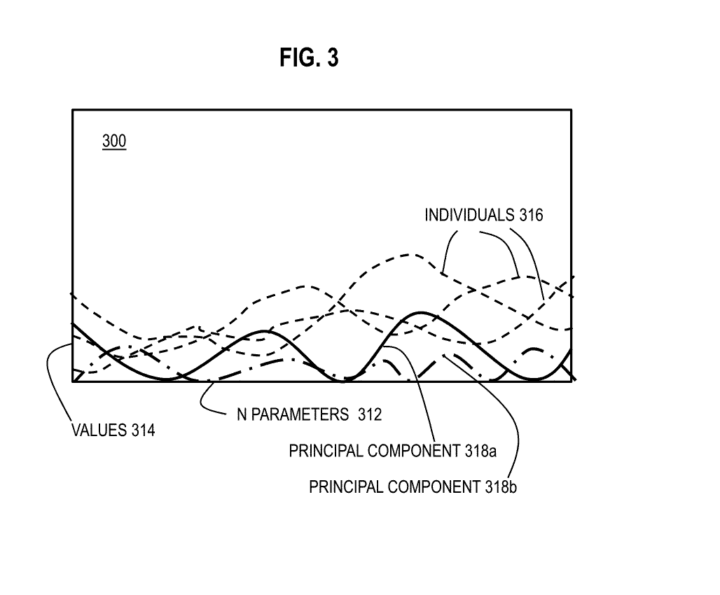

FIG. 4 is a flow chart that illustrates an example method 400 for scoring the deviations of one or more individuals in one or more populations from a first population, according to various embodiments. Although steps are depicted in FIG. 4 as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

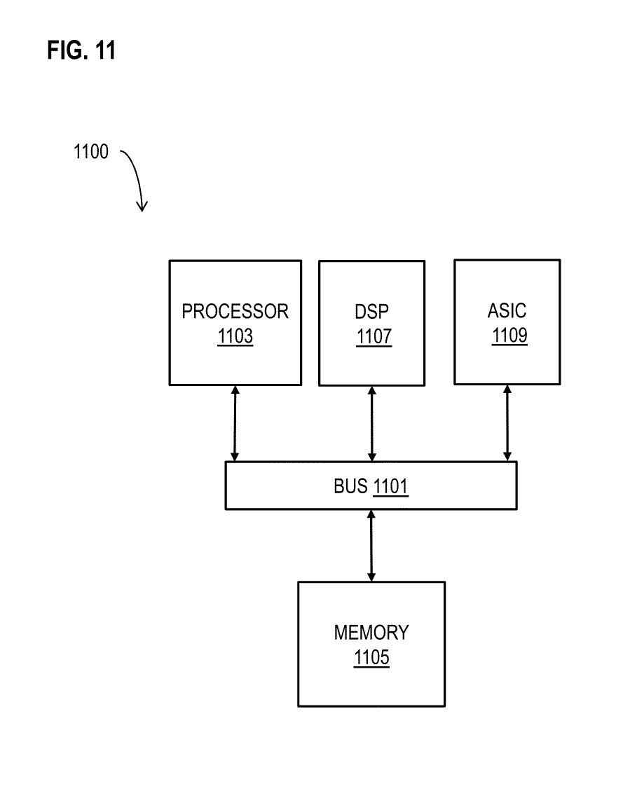

In step 401, N dimensional profile data is obtained on a processor (such as computer system in FIG. 10 or chip set in FIG. 11) for multiple individuals. Any method may be used to obtain the data. In come embodiments the data is obtained by performing the measurements, e.g., using cytometry with multiple labels for different proteins expressed on or within a cell, and storing the values on a computer readable medium. In some embodiments, step 401 involves retrieving data from a database, either locally or remotely using data packets over a communications network, or some combination. In some embodiments some of the data is entered manually or scanned onto a processor for storage on a computer readable medium.

In step 403, individuals are assigned membership in certain populations, either a priori or a posteriori, either manually or automatically. For example, an individual is assigned to a normal population if the individual was obtained in a sample from a normal patient; and an individual is assigned to a diseased population if the individual was obtained in a sample from a diseased patient. In some embodiments, a diseased cell has a certain protein marker or combination of markers, and the cell is allocated to a normal or diseased population based on those markers. In some embodiments, cluster analysis is used to find any natural divisions between the populations in N-space. In some embodiments, step 403 includes principal component analysis, and the clusters are defined in principal component space of just a few of the most important principal components.

In step 404, a vector distance metric is defined for computing distance between two individuals. For example, a weighted Euclidean distance is defined as the distance metric, in which the weights are based on the magnitude of the principal component that explains most of the variance in the first population.

In step 405, individuals in a next population are determined, either based on the populations defined in step 403 or using a new definition. In some embodiments, individuals from the next population include one or more individuals from the first population, e.g., a subset of the first population. In step 407, the profile data for the next individual is determined, e.g., by retrieving from a local or remote database. The current individual of interest is called the subject individual.

In step 409, the first neighbor of the subject individual is determined. The first neighbor is the individual in the first population that is closest to the subject individual using the vector distance metric. The corresponding first distance value d1 is also retained. In step 411, the second neighbor of the subject individual is determined. The second neighbor is the individual in the first population that is closest to the first neighbor using the vector distance metric. The corresponding second distance value d2 is also retained.

In step 413, the deviation score is determined for the subject individual based on a ratio r of the first distance value d1 divided by the second distance value d2. For example, the ratio is used directly as the deviation score for the subject individual. In other embodiments, other functions of d1 and d2 are used, such as a mean or a harmonic mean of the two distances, or difference of the two values, or modulus of d1 relative to d2, among others.

In step 421, it is determined if there is another subject individual to score. If so, control passes back to step 407, described above, to get the profile data for the next subject individual. If not, then control passes to step 423.

In step 423, the score is used in one or more analyses to make decisions on how to treat or use the population from which the one or more subjects are drawn. For example, multiple subject individuals in the current population are sorted based on their respective scores, or the population is characterized based on the mean or standard deviation or histogram or other statistics of the scores in the population. Control then passes to step 431.

In step 431, it is determined if there is another subject population to score. If so, control passes back to step 405, described above, to define the next population. If not, then control passes to step 433.

In step 433, the scores of one or more populations are used in one or more analyses to make decisions on how to treat or use the population. For example, multiple populations are sorted based on their respective average scores or other score statistics, or the population characteristics are compared, e.g., to compare various treatment or successive samples during treatment. The process then ends.

In step 435 results are presented on a display device (such as display 1014 in FIG. 10) or used to change or start an action such as operating on a member of one or more populations, or some combination. In some embodiments, step 435 includes changing or starting actions (such as treatment) based on differences in the individuals. In some embodiments, step 435 includes changing or starting actions (such as a particular treatment) based on differences in the populations. When the populations represent members of social media, the operation includes actions, such as presenting information, such as weather or stock prices or advertising, based on the differences in the individuals or differences in the populations.

### 2. Example Embodiments

### 2.1 Varicella-Zoster Virus Remodeling Study

According to an example embodiment, the differences in populations of infected cells from healthy cells are determined for Varicella-zoster virus (VZV), an a-herpesvirus carrying a linear DNA genome encoding over 70 proteins. The model for the pathogenesis of primary VZV infection is host entry via respiratory epithelial cells, infection of T lymphocytes (T cells that learn the surface protein expression of pathogens as part of the adaptive immunoresponse system) in local lymphoid tissue (lymphotropism), and viral transport by infected T cells to skin sites of replication. VZV transfer from tonsil T cells to skin has been demonstrated in vivo. Nevertheless, to determine molecular changes in differentiated host cells targeted in pathogenesis is challenging. One challenge is posed by the fact that the percentage of T cells that gets infected with the virus ranges from 5-10% of all cells (closely resembling infections under natural conditions for any pathogen), thereby presenting a much smaller population size for comparisons. Other challenges are: that tonsil T cells are heterogeneous differentiated primary cells; that primary host cells are in an asynchronous state of activation/deactivation; and that virally transformed T cell lines do not reproduce the diversity of primary T cells encountered by the virus in the natural host.

Single cell mass cytometry with metal isotope labeled antibodies (CyTOF) allows simultaneous detection of over 40 proteins in single cells whether on the surface or internal (Bendall et al., 2011; Bjornson et al., 2013). Measuring combinatorial expression of surface and signaling proteins by single cell mass cytometry to generate N-dimensional profile data for each cell, and using an embodiment of the method of FIG. 4, it was revealed that VZV modified the heterogeneity of primary tonsil T cells dramatically. Profile data for each cell was based on cell surface expression of 25 proteins (CD proteins) associated with T cell activation and skin homing, and phosphorylation of 16 proteins involved in intracellular signaling. Such analysis is especially challenging using previous techniques because of the small number of infected T cells compared to healthy T cells and the large number of expressed protein levels (dimensions) contributing to the profile data for each cell.

It was concluded that, encountering T cells in their inherently stochastic states, VZV orchestrated a continuum of changes regardless of basal phenotypic and functional characteristics. VZV activated T cells, exploiting both Zap70 and Akt signaling pathways in naïve as well as memory cells by a T cell receptor (TCR)-independent process, and re-configured cell surface proteins to profiles that promote skin trafficking while incapacitating immune function.

Other viruses are likely to have evolved similar capacities for remodeling differentiated cells to support pathogenesis, despite their considerable heterogeneity at the single cell level in the natural host. This capacity can be determined using the techniques presented here.

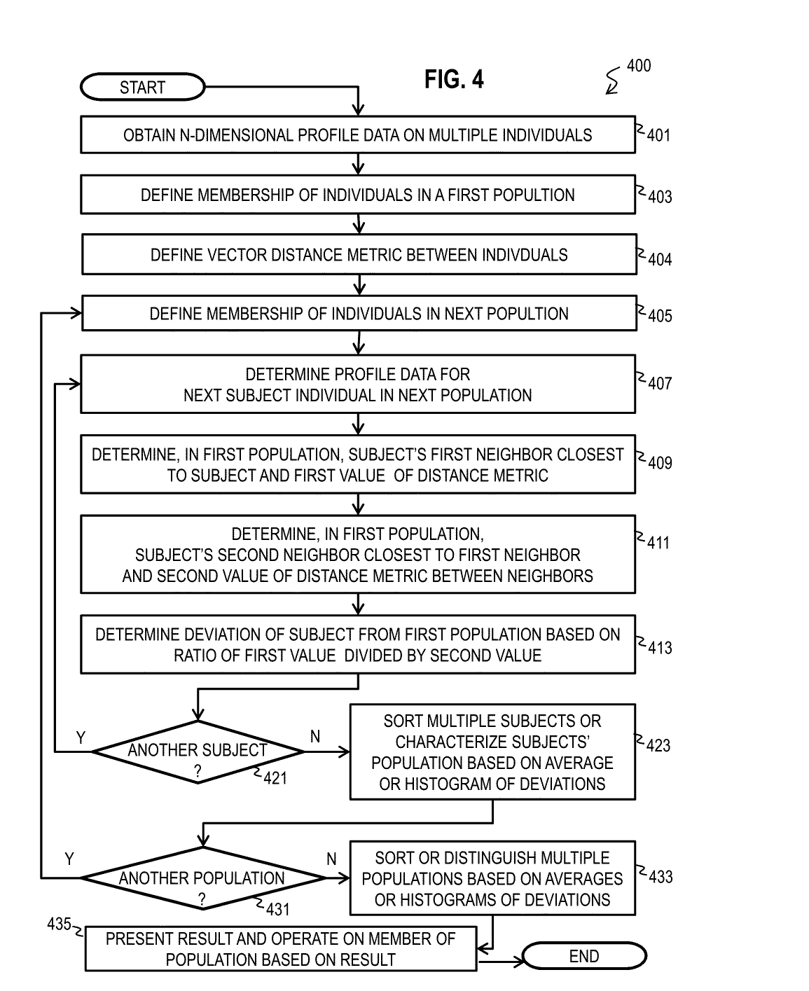

FIG. 5 is a diagram that illustrates a viral infection that causes T cells to migrate to a skin site, investigated according to one embodiment. VZV is a medically important human herpesvirus that causes varicella (chickenpox) and zoster (shingles). The role of lymphotropism in allowing viral transport to skin sites of replication has been known to be an essential event during primary VZV infection for decades. Importantly, the transfer of VZV into human skin by human tonsil T cells has been proved to be a biologically functional mechanism for VZV pathogenesis in vivo. When VZV infected primary tonsil T cells are injected into the circulation of immunodeficient (SCID) mice with human skin xenografts, T cells exit into skin tissue and typical skin lesions are formed. Other types of human cells do not transport VZV to skin in vivo. (See, for example, Ku et al., J Exp Med 2004.) In FIG. 5 are depicted the tonsil 510 with tonsil cells 514 and epithelial cells 512, where T cells 520 reside. The virus 501 enters, e.g. through tonsillar crypts 516, infects some T cells 522, which through efferent lymphatics enter the circulation of the host. The infected T cells 522, now configured for skin habitation, pass from the circulation system into the skin to form lesions 530 that dispense the virus 501 to begin the next cycle.

The object of this study was to determine what distinguishes the infected cells from the uninfected cells: are certain T cell vulnerable to attack, or does the virus reconfigure any T cell for its own purposes. High dimensional profile data was collected by mass cell cytometry for a large number of individual cells from each of one or more samples from five different human subjects. Individual profile data was based on the expression of 17 phenotypic markers (cell surface proteins) of the 41 measured proteins.

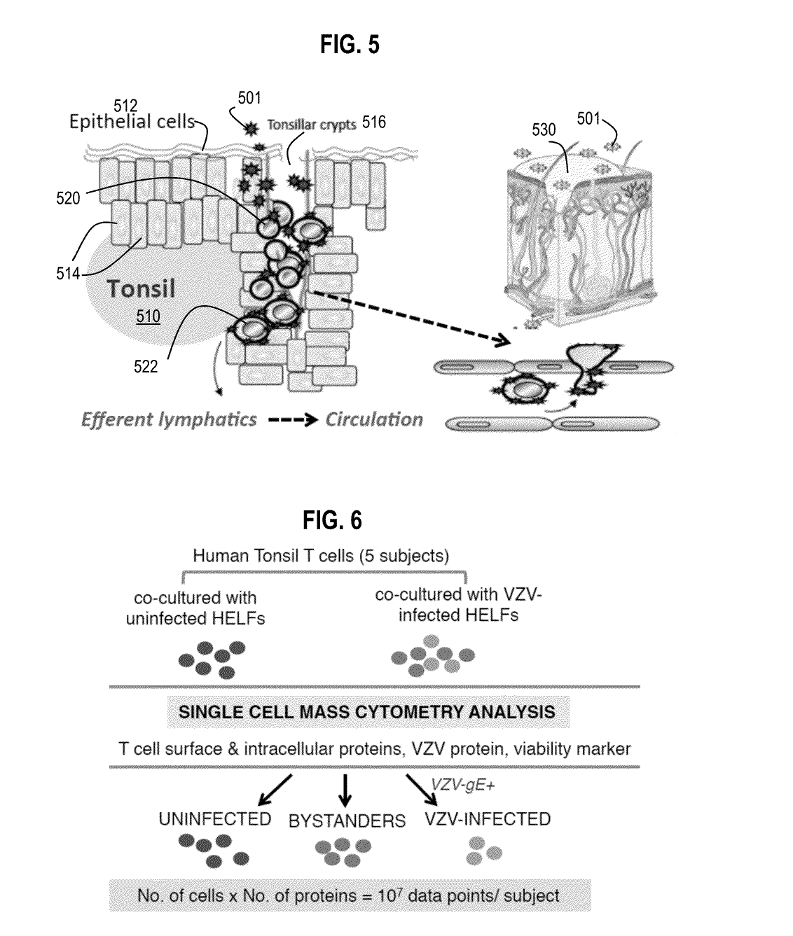

FIG. 6 is a diagram that illustrates populations of T cells among which the deviations of individuals are scored, according to one embodiment. Analysis of primary human tonsil T cells (about 2 to 3 million cells from five subjects) with up to 44 parameters/cell (including cell length, DNA content, surface markers and intracellular proteins) yielded a multi-parametric high-resolution map of the tonsil T cell repertoire. Basal phenotypes of uninfected (UI) T cells were determined with antibodies to 25 surface markers associated with T cell activation, differentiation and trafficking and analyzed with three unsupervised clustering algorithms for a posteriori population definition. Four “core” clustering markers—CD4, CD8, CD45RO (memory) and CD45RA (naïve)—of the 44 parameters were used. The cluster of differentiation (cluster of designation or Classification Determinant, abbreviated here as CD) is a protocol used for the identification and investigation of cell surface molecules providing targets for immunophenotyping of cells. CD molecules can act in numerous ways, often acting as receptors or ligands (the molecule that activates a receptor) important to the cell resulting in initiation of a signaling cascade. In addition some CD proteins play a role in cell adhesion. CD for humans includes numbers up to 350 as of 2009.

Incubation of tonsil CD3+ T cells with VZV-infected human embryonic lung fibroblasts (HELF) yielded infected T cells that express VZV glycoprotein E (gE, represented hereinafter by the notation V+) T cells, and uninfected bystander (represented hereinafter by the notation Bys) T cells. The V+ T cells amounted to about 5 to 10% of the co-cultured cells. Uninfected (UI) T cells (incubated with uninfected HELF) did not express gE, confirming the specificity of gE as an indicator of infection. By principal component analysis (PCA) and agglomerative clustering, V+ T cells presented a distinct hierarchical profile compared to the corresponding Bys and UI T cells. Notably, Bys and UI T cells were similar, indicating that the basal phenotypic hierarchy of tonsil T cells was not altered indirectly by exposure to infected HELF, V+ T cells or secreted proteins. In contrast, V+ T cells were distributed into two groups both by PCA and agglomerative clustering which, unlike Bys and UI T cells, were not defined by expression of the four core markers.

Of the 44 possible proteins, including signaling and cell surface proteins, changes in 17 cell surface proteins were analyzed, of which changes in at least 16 were observed among the UI, Bys and V+ populations. In addition changes were observed in 10 signaling proteins, but these were not included as parameters (dimensions) in the illustrated embodiment. Spanning trees with a target of 50 hierarchical nodes were determined, allowing visualization and quantitation of protein expression on cells within each hierarchical node. Most of the assigned nodes could be broadly classified into three groups: CD4+CD45RO+ (CD4+Memory, abbreviated CD4+M), CD4+CD45RA+ (CD4+Naïve, abbreviated CD4+N), and CD8+CD45RA+ (CD8+Naïve, abbreviated CD8+N). Similarly, orthogonal transformation using Principal Component Analysis (PCA) produced three major T cell clouds with CD4+M, CD4+N and CD8+N phenotypes.

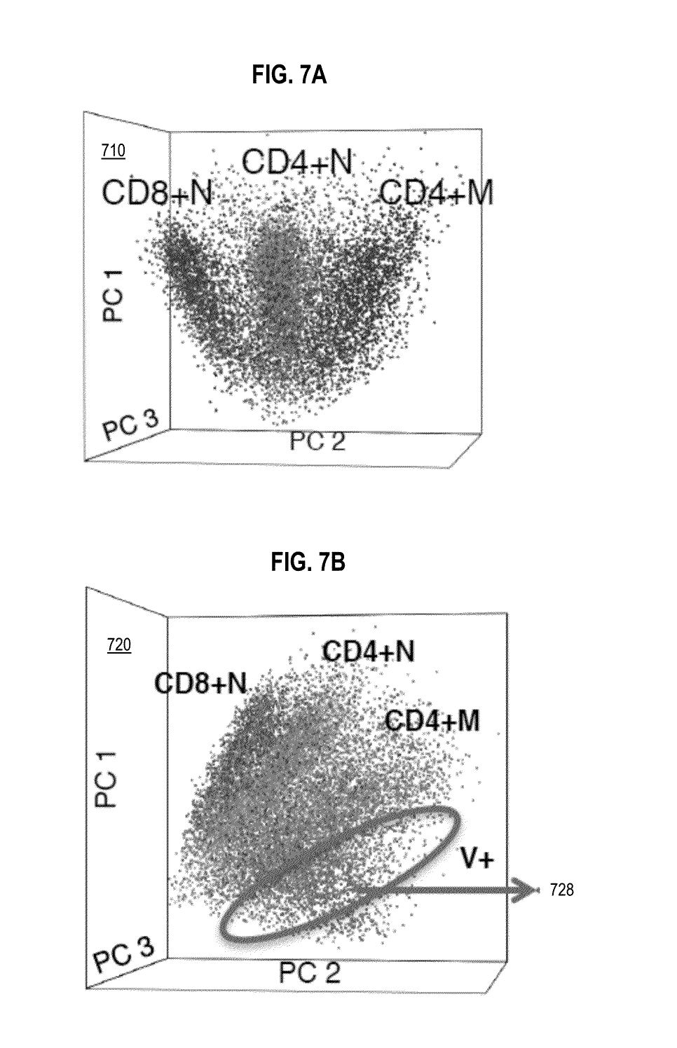

FIG. 7A is a graph 710 that illustrates three population clusters of T cells mapped relative to three principal components as the three axes of the 3D plot, according to an embodiment. These population clusters were based on profile data including the following surface proteins: the four core proteins plus CD3ε, CD7, CD69, CD44, CD45, CD49d, CD11a, CD127, CD27, CCR7, CD25, CD28, CD38. The primary difference among the three clusters was in the expression CD8+N, expression of CD4+N, and expression of CD4+M. No difference among the three clusters were detected between UI and Bys T cells, which both showed similar sets of clusters. It is noteworthy that though these data were from 5 unrelated human subjects, the distribution is highly consistent. It can be concluded that the tonsil T cell repertoire comprises heterogynous cell phenotypes identified by combinatorial expression of these 17 surface proteins. Furthermore, Bys and UI T cells were indistinguishable, indicating no evidence of secondary cytokine induced alterations in Bys T cells growing in proximity with the infected V+ T cells. It is concluded that altered cell surface proteins in V+ T cells were triggered from within the cells and not induced by the extracellular environment or signaling.

FIG. 7B is a graph 720 that illustrates three population clusters of UI and Bys T cells and a new population cluster of virally infected T cells mapped relative to the three principal components, according to an embodiment. The V+ T cells formed a distinct cluster of cells indicated by the ellipse 728. The eigen directions of the 3 sub-populations in the uninfected population are very different and even when PCA is applied to the entire dataset (including V+ cells) the differential alignments is not destroyed in the dimension reduced data space.

The method 400 of FIG. 4 was applied to determine whether the population of infected cells were similar to or different from the UI and Bys T cells. If similar, then the V+ T cells could be due to attacks on a minor subpopulation of uninfected cells that does not form its own cluster. If different, then it is concluded that the UI T cells are reprogrammed by the virus to become configured to inhabit skin tissue.

In step 401, The 17-protein profile data is used as the N-dimensional data. In step 403, the first population is the uninfected (UI) T cells, designated the uninfected sub-population UIs. In step 404 the vector distance metric, d, is an unweighted Euclidean distance. In step 407, the next V+ T cell profile data, v, is selected from the V+ T cell sub-population (Vs); thus, v ∈ Vs.

In step 409, the first neighbor uv and first distance d1 are determined as given by Equation 1 and Equation 2, respectively.

uv=argmin d(u, v)for u ∈ {UIs} (1)

d1(v)=d(uv, v) (2)

In step 411, the second neighbor uuv and second distance d2 are determined as given by Equation 3 and Equation 4, respectively.

uuv=argmin d(u, uv) for u ∈ {UIs−uv} (3)

d2(v)=d(uuv, uv) (4)

Under the null hypothesis of no remodeling of the cell surface markers in the virus sub-population, the distance d1 (v) between a typical viral cell v and its nearest uninfected neighbor (uv) will be similar to its associated second distance d2(v). A non-parametric Wilcoxon test is used to compare the paired distances d1 and d2 for all viral cells v in that sub-population Vs. If significant evidence is found in favor of the alternative hypothesis that the first distances d1 are stochastically larger than the second distances d2, then rejection of the null hypothesis of no remodeling of the cell surface markers is implied. Note that under the null hypothesis of no remodeling of any of the surface markers the ratio, r(v), of the distances given by Equation 5

r(v)=d1(v)/d2(v) for v ∈ Vs (5)

will have a symmetric distribution around a value of 1.0. Under the alternative hypothesis of remodeling in the viral population, the V+ cells would be distant from its uninfected neighbor and the ratio r(v) would have mean greater than 1. Steps 407 through 413 are repeated for all v∈ Vs.

Next, e.g., in step 423, co-ordinate wise tests with False Discovery Rate based multiplicity corrections are conducted to detect the nature of changes in the remodeled viral cell clusters. For data-analysis, the univariate density f of the expression values is modeled by a mixture of a non-parametric density g and the degenerated density g and the probability α of expression of the corresponding protein, given by Equation 6.

f=(1-α)*δ₀+α*g (6)

For most proteins, the non-parametric density g could be well approximated by unimodal, right-skewed distributions with support in the interval [1, 7].

The power of these tests depends on the cardinality of the concerned V+ sub-population, Vs. These tests are conservative and if the size of the V+ sub-population is very small, then the power is low and remodeling might not be detected in those cases. A detailed analysis of the operational characteristics of the algorithm and the effectiveness of the methodology can be explicitly specified.

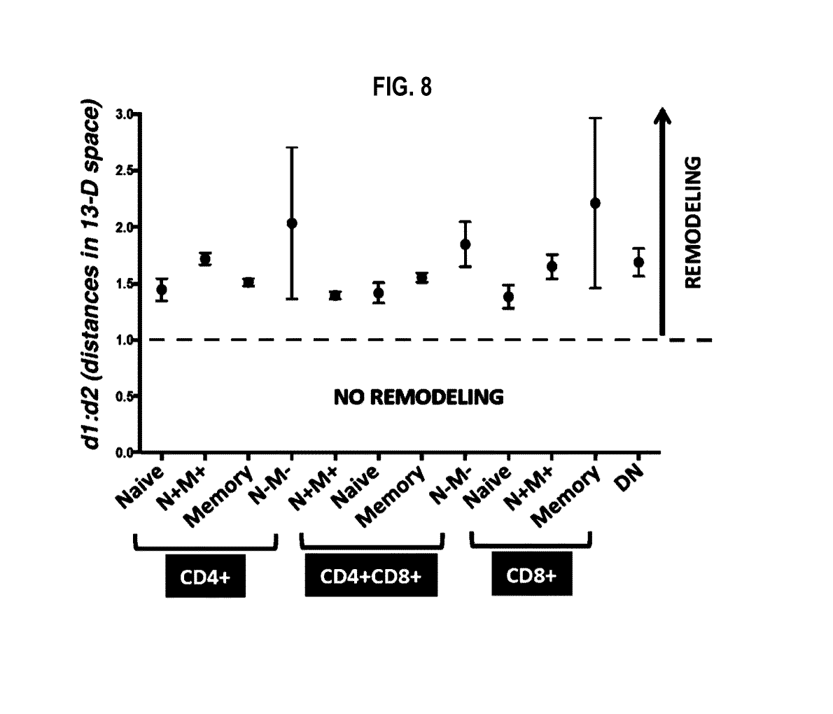

Based on the four core proteins, 12 major and minor sub-populations were defined for UI, Bys and V+ T cell populations by a binary filter, distinguishing subpopulations in which the protein was expressed or not expressed. Of the 2⁴=16 possible combinations, the sizes of four combinations were found to contain very few cells (<30) and so were left out of the sub-population analysis. For each patient sample, the respective sub-populations are denoted by UIs, BYs and Vs for s ∈ S={1, 2, . . . , 12}. All such subpopulations showed remodeling. FIG. 8 is a graph that illustrates a deviation score of infected cells from uninfected cells, supporting remodeling of T cells by the virus, according to an embodiment. The horizontal axis indicates sub populations of two proteins, CD4 and CD8, and the combination, in naïve T cells, or memory T cells, or both. The vertical axis indicates the value of the ratio r of d1/d2. The various points indicate the average value and the standard deviation, all more than one standard deviation above the value 1.0. It is concluded that VZV directs ‘remodeling’ of the infected T cell regardless of the basal state rather than infecting T cells with pre-existing characteristics that promote skin homing. This conclusion was validated with further experiments that helped to elucidate the mechanism of reprogramming, which is not described further herein.

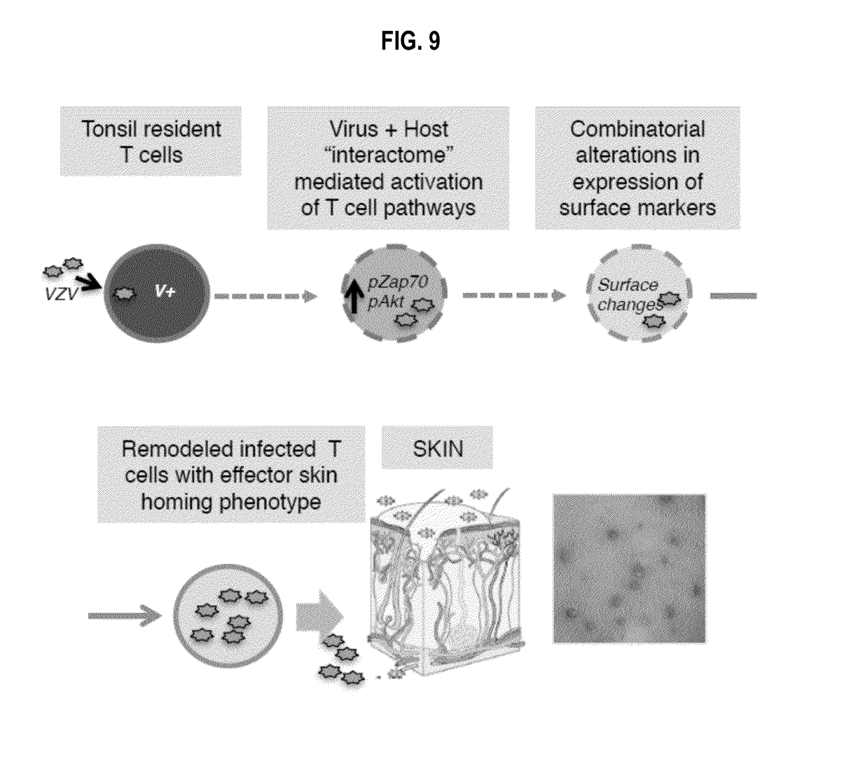

FIG. 9 is a diagram that illustrates a model of disease progression inferred from the score of deviations of individuals of high dimensionality, according to an embodiment. The first panel indicates a tonsil resident T cell being infected by a VZV virus. In the second panel, the VZV virus uses the cell machinery to activate T cell differentiation for skin homing, by combining host and virus interacting genes to produce proteins and other molecules that interact in the cell (called the “interactome”) to mediate the activation pathways for the T cell. The result, shown in the third panel, is an alteration in the combinatorial expression of cell surface marker proteins. The fourth panel indicates the infected T cell is now remodeled with effector skin homing phenotype. The fifth panel shows the cell resident in the skin of the host and releasing the virus. The sixth panel shows an image that depicts pox on the skin surface due to the skin homing T cells resident there.

In some embodiments, in step 435, treatments adjusted to target the reprogrammed T cells, or different treatments, such as the efficacy of different vaccines, are determined based on the differences in the deviations from a normal population of different populations treated by different candidate vaccines.

### 2.2 Various Distance Metrics

Determination of phenotypic and/or functional distance (quantified difference) between individual entities (single cells in case of biological systems) in a multidimensional parameter space is based on differences in simultaneous expression of chosen marker molecules. Such distances can be either based on natural equi-representative measures of differential protein expression values recorded per cell or based on a weighted measure of all the measured parameters, such weights being calculated discretely for each measured parameter as described below. Each protein can be assigned a weight that is either data-dependent or user-dependent. Data-dependent weights can be based on the leading principal component loading amplitudes.

User-dependent weights for a parameter can be constructed based on its abundance, and/or function, and/or its biological relevance to properties being studied. For example, single cell parameters are based on the expression of surface proteins (e.g. CD4, CD8, etc.) and several intracellular proteins (e.g. IkB-alpha, interferon-stimulated proteins such as ISG15, ISG20, p53, etc.) or phosphoproteins (e.g. pSTAT1, pIRF3, pCREB, pAkt, etc.). Each protein is assigned a weight based on its functionality and/or its connectivity to other proteins using publicly available data from databases such as GeneCards. For example, using the GeneCards Inferred Functionality Score (GIFtS) (Harel et al 2009, BMC Bioinformatics) which allows a quantitative assessment of a gene's annotation status with potential relevance to the degree of relevant functional knowledge, a weight may be assigned to each measured parameter that reflects the functionality of that particular measured parameter. This weight may be further refined by incorporating measures of protein interactions that the parameter being analyzed is engaged in as defined by number of interacting partners identified in UniprotKB, GeneCards, etc. The cumulative assigned “weight” for the function of a protein calculated in this manner is then a composite of both its functionality and involvement in different signaling networks. Thus if there are p proteins serving as the parameters of the profile data, then the weight associated with differences in the jth protein is given by Equation 7.

$$wj = \frac{Gj + Ij}{{\sum }_{k = 1}^{p} Gk + Ik} j = 1 , 2 , … p \qquad ( 7 )$$

Where Gj is the GIFtS and Ij is the number of interactants with the jth protein from one of the sources indicated above. So the corresponding weighted distance is given by Equation 8.

$$d ( x , y ) = {\sum }_{k = 1}^{p} wk \cdot d ( xk , yk ) \qquad ( 8 )$$

Where x and y are two individuals represented by profile data and xk and yk are the kth parameter of the profile in the x and y individuals, respectively, and d is any distance metric on the real number domain.

For example, in some embodiments, cells are analyzed for the expression levels of CD4 and p53 using CyTOF from virus infected and uninfected samples. CD4 has a GiFtS score of 73 as calculated by the GeneCards database and an interactions score of 244 (the number of known CD4 interacting proteins identified by GeneCards). An example simple cumulative score for CD4 would be 317 based on this approach. In contrast, the calculated score for p53 would be (GiFtS=81, interactants=930) 1011. The measured protein expression levels on single cells for CD4 and p53 are assigned weights of 317/(317+1011)˜0.24 and 1011/(317+1011)˜0.76 reflecting their relative biological importance. In some embodiments, the weighted single cell values are then used for calculating the distances between every single cell within and across infected and uninfected sample. In some embodiments, the distance between values of these proteins is multiplied by these weights, as in Equation 8.

Note that in this approach, samples of single cells can also be derived from other biologically different conditions, such as natural virus-infected and attenuated virus-vaccinated cells (infection versus vaccination), normal and diseased cells, etc. The parameters incorporated for distance estimation can also involve an averaged “bulk” measure that is obtained for similar samples under identical experimental conditions. For example, before comparison of single cells from infected and uninfected human primary peripheral B cells, the weighted single cell parameter is modified to include a single average measure of infected and uninfected plasma virus-specific antibody levels for every single cell being analyzed.

### 2.3 Progression of Deviation Scores

Using similarly calculated unweighted or weighted single cell measures, the ratio of distances between single cells within or across biological samples can be used to determine the progression (“gradient” or “single cell continuum”) of phenotypic and signaling changes in cells that are induced by exogenous factors like viruses, cytokines and growth factors, pathway inhibitors etc. Such a progression can also be derived from samples that are obtained at different time periods in a kinetic experiment, leading to identification of single cell changes that occur in a time-dependent manner.

### 2.4 Effectiveness of Drugs or Other Treatments

In some embodiments, e.g., during step 435, the potency and specificity of drugs is determined based on the quantified changes in single cells when a well characterized measure is available to determine these traits at the single cell level. For example, measurement of single cell expression of viral antigens in infected samples treated with an antiviral drug or treated with a control compound can be combined with other single cell parameters that measure antiviral responses such as expression of interferon-stimulated genes (ISGs) such as ISG15, IFIT1, IFIT2, etc. to determine whether drug treatment results in significantly reduced virus replication and antiviral gene expression in single cells.

### 2.5 Classification of Diseased State

In some embodiments, e.g., during step 423 or step 433, disease progression in individual cells is quantified, e.g., in cases of cancer or Alzheimer's disease. For example, the frequency (histogram) of distance ratios can be used to determine the extent of disease progression in individual cells. These experimentally derived ratios can then be compared with control distance ratio histograms that are obtained from qualified normal and cancerous/Alzheimer' s diseased samples (reference distance values) to quantify the extent of progression of single cells in a test sample towards the perturbed state.

### 2.6 Transcription Differences

In some embodiments, e.g., during step 435, transcriptome distance is determined between individual cells based on RNA transcript profiles in individual cells. In such embodiments, single cells are flow cytometry sorted and analyzed by quantitative real-time RT-PCR using a commercially available technology platform such as Fluidigm microfluidics chip assays for 100 or more transcripts per cell. These transcripts reflect the expression of genes corresponding to presence of virus, cell type, antiviral responses, etc. The expression of several transcripts (measured parameters per cell) can be used to characterize a single cell in multidimensional parameter space as above for protein measures. As stated above, each RNA transcript can also be assigned a weight depending on its abundance and/or function and/or its relevance to properties being studied such measures being derived from the gene encoding the transcript or the protein that is encoded by it.

### 2.7 Ordering Cells on a Continuum

In some embodiments, e.g., during step 435, the hierarchical order of cells is determined based on the expression of chosen determinants and the cell's distance ratio from the basal state. This can help to establish a quantitative continuum of differentiation, as observed in immune cells, which is based on chosen single cell parameters and weighted measures of biological functionality at either the transcriptome or the proteome level in single cells. Current methods to hierarchically cluster single cells are based on aggregate measures that do not involve pairwise comparison of large numbers of single cells in multidimensional parameter space and do not incorporate measures of biological function for the measured parameters that are used for clustering.

### 2.8 Similarities of Individuals in Different Social Networks

In some embodiments, e.g., during step 435, distances are calculated between social entities (“humans”) in social networking datasets to determine if two persons are significantly similar to each other. For example, when comparing two population samples of social data where each sample contains large numbers of test subjects and several parameters have been measured for each subject (age, location, income, membership in interest groups, nature of internet sites visited, etc.), the method 400 is used to compare each subject with every other subject in these samples to identify significantly similar subjects. Such information may be of use in determining associative predictions for related individuals. For example, two closely related subjects in multidimensional parameter space are likely to engage in similar consumer choices or detrimental behavior suitable for intervention.

### 3. Experimental Procedures

The entire contents of the following references are hereby incorporated by reference as if fully recited herein, except for terminology inconsistent with that used herein. Tonsil T cell separation and VZV infection was done as described previously (Ku et al., 2002). Paraformaldehyde fixed cells (2 to 3×10⁶ cells) were incubated with metal isotope conjugated antibodies as reported by Bendall et al., 2011. Antibody reagents with tags are listed in the Extended Experimental Procedures. Briefly, surface antibodies were added to a total reaction volume of 100 μl for 30 min followed by permeabilization with cold methanol (10 minutes, min, at 4° C.) and intracellular staining for 30 min. Cells were resuspended in 1:4000 191/193Ir DNA intercalator (Ornatsky et al., 2008) (DVS Sciences, Richmond Hill, Ontario, Canada), and incubated overnight at 4° C. Cells were washed, resuspended in distilled water and analyzed on the CyTOFTM mass cytometer (DVS Sciences) (Bandura et al., 2009). Cytometer setting and data acquisition was done as described (Bendall et al., 2011; Finck et al., 2013). Approximately 200,000 events were acquired per sample. To make all samples maximally comparable, all data were acquired using internal metal isotope bead standards (Finck et al., 2013) and normalized to the standards before analysis.

Protein expression data provided the values for the individual profile data. Within Cytobank, zero expression values are given random values between −1 and 1 to spread the distribution around the zero bin (Kotecha et al., 2010). Outliers were removed by manual gating in Cytobank and gated data was exported as arcsinh-transformed expression values. If y is the expression value in original scale, then the arcsinh-transformed value ŷ is given by Equation 9.

\hat{y}=log e(y+\sqrt{y²+1}) (9)

For most proteins, the transformed values were less than 6 and a substantial fraction was between ±1, which indicates a high level of non-expression in these datasets. Randomization of zero values (usually used in Cytobank) may distort the distribution of the protein expressions and lead to erroneous inferences. Note that, for x ∈ [−1, 1], y ∈ [−0.881, 0.881]. Therefore the randomization effect was removed by thresholding the arcsinh values y at the conservative threshold of 1, as given by Equation 10.

z=0 if ŷ<1

z=ŷ if ŷ≧1 (10)

However, due to thresholding, the distribution of Z values is no longer continuous.

### 4. Hardware Overview

FIG. 10 is a block diagram that illustrates a computer system 1000 upon which an embodiment of the invention may be implemented. Computer system 1000 includes a communication mechanism such as a bus 1010 for passing information between other internal and external components of the computer system 1000. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit).). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of one or more methods described herein.

A sequence of binary digits constitutes digital data that is used to represent a number or code for a character. A bus 1010 includes many parallel conductors of information so that information is transferred quickly among devices coupled to the bus 1010. One or more processors 1002 for processing information are coupled with the bus 1010. A processor 1002 performs a set of operations on information. The set of operations include bringing information in from the bus 1010 and placing information on the bus 1010. The set of operations also typically include comparing two or more units of information, shifting positions of units of information, and combining two or more units of information, such as by addition or multiplication. A sequence of operations to be executed by the processor 1002 constitutes computer instructions.

Computer system 1000 also includes a memory 1004 coupled to bus 1010. The memory 1004, such as a random access memory (RAM) or other dynamic storage device, stores information including computer instructions. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of computer instructions. The computer system 1000 also includes a read only memory (ROM) 1006 or other static storage device coupled to the bus 1010 for storing static information, including instructions, that is not changed by the computer system 1000. Also coupled to bus 1010 is a non-volatile (persistent) storage device 1008, such as a magnetic disk or optical disk, for storing information, including instructions, that persists even when the computer system 1000 is turned off or otherwise loses power.

Information, including instructions, is provided to the bus 1010 for use by the processor from an external input device 1012, such as a keyboard containing alphanumeric keys operated by a human user, or a sensor. A sensor detects conditions in its vicinity and transforms those detections into signals compatible with the signals used to represent information in computer system 1000. Other external devices coupled to bus 1010, used primarily for interacting with humans, include a display device 1014, such as a cathode ray tube (CRT) or a liquid crystal display (LCD), for presenting images, and a pointing device 1016, such as a mouse or a trackball or cursor direction keys, for controlling a position of a small cursor image presented on the display 1014 and issuing commands associated with graphical elements presented on the display 1014.

In the illustrated embodiment, special purpose hardware, such as an application specific integrated circuit (IC) 1020, is coupled to bus 1010. The special purpose hardware is configured to perform operations not performed by processor 1002 quickly enough for special purposes. Examples of application specific ICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1070 sends and receives electrical, acoustic or electromagnetic signals, including infrared and optical signals, that carry information streams, such as digital data.

The term computer-readable medium is used herein to refer to any medium that participates in providing information to processor 1002, including instructions for execution. Such a medium may take many forms, including, but not limited to, non-volatile media, volatile media and transmission media. Non-volatile media include, for example, optical or magnetic disks, such as storage device 1008. Volatile media include, for example, dynamic memory 1004. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1002, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1002, except for carrier waves and other signals.

Logic encoded in one or more tangible media includes one or both of processor instructions on a computer-readable storage media and special purpose hardware, such as ASIC 1020.

Network link 1078 typically provides information communication through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090. A computer called a server 1092 connected to the Internet provides a service in response to information received over the Internet. For example, server 1092 provides information representing video data for presentation at display 1014.

The invention is related to the use of computer system 1000 for implementing the techniques described herein. According to one embodiment of the invention, those techniques are performed by computer system 1000 in response to processor 1002 executing one or more sequences of one or more instructions contained in memory 1004. Such instructions, also called software and program code, may be read into memory 1004 from another computer-readable medium such as storage device 1008. Execution of the sequences of instructions contained in memory 1004 causes processor 1002 to perform the method steps described herein. In alternative embodiments, hardware, such as application specific integrated circuit 1020, may be used in place of or in combination with software to implement the invention. Thus, embodiments of the invention are not limited to any specific combination of hardware and software.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server 1092 transmits program code for a particular application, requested by a message sent from computer 1000, through Internet 1090, ISP equipment 1084, local network 1080 and communications interface 1070. The received code may be executed by processor 1002 as it is received, or may be stored in storage device 1008 or other non-volatile storage for later execution, or both. In this manner, computer system 1000 may obtain application program code in the form of a signal on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set 1100 upon which an embodiment of the invention may be implemented. Chip set 1100 is programmed to perform one or more steps of a method described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of a method described herein.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1105 also stores the data associated with or generated by the execution of one or more steps of the methods described herein.

### 5. Extensions, Modifications and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. A method comprising:
collecting, on a processor, first population data comprising individual profile data for each individual in a first population comprising a first plurality of individuals, wherein the individual profile data indicates values for each parameter of a plurality of parameters;
determining, on the processor, the individual profile data for a subject drawn from a second population comprising a second plurality of individuals;
determining on the processor, within the first population, a first neighbor for the subject, wherein
the first neighbor is different from the subject, and
a first value of a vector distance metric between the individual profile data for the subject and the individual profile data for the first neighbor is less than a value of the vector distance metric between the individual profile data for the subject and the individual profile data for any other individual of the first population;
determining on the processor, within the first population, a second neighbor for the subject, wherein
the second neighbor is different from the subject and the first neighbor, and
a second value of the vector distance metric between the individual profile data for the first neighbor and the individual profile data for the second neighbor is less than a value of the vector distance metric between the individual profile data for the first neighbor and the individual profile data for any other individual of the first population;
determining on the processor a deviation of the subject from the first population based on a ratio of the first value of the vector distance metric divided by the second value of the vector distance metric; and,
presenting on a display device a result based on the deviation.

2. A method as recited in claim 1, wherein the vector distance metric is a weighted vector distance metric, wherein a difference between values for two individuals of each parameter of the plurality of parameters is multiplied by a weight specific to that parameter.

3. A method as recited in claim 1, further comprising:
determining for each other individual of the second plurality of individuals, a corresponding first neighbor and a corresponding second neighbor;
determining for each other individual of the second plurality of individuals, a corresponding first value of the vector distance metric and a corresponding second value of the vector distance metric; and
determining for each other individual of the second plurality of individuals, a corresponding deviation from the first population based on a ratio of the corresponding first value of the vector distance metric divided by the corresponding second value of the vector distance metric.

4. A method as recited in claim 3, further comprising characterizing the second population by a frequency of occurrence in a plurality of deviation bins.

5. A method as recited in claim 3, further comprising:
determining for the second plurality of individuals, an average deviation; and
determining whether the second population is different from the first population based on the average deviation.

6. A method as recited in claim 5, wherein the first population comprises a plurality of normal individuals, and the second population comprises a plurality of individuals with a particular condition.

7. A method as recited in claim 5, wherein the first population comprises a plurality of untreated individuals with a particular condition, and the second population comprises a plurality of individuals with the first condition who have been treated using a first treatment.

8. A method as recited in claim 3, further comprising sorting the second plurality of individuals by the corresponding deviations.

9. A method as recited in claim 5, further comprising:
determining the individual profile data for a control subject drawn from a third population comprising a third plurality of individuals;
determining, within the first population, a first control neighbor for the control subject, wherein
the first control neighbor is different from the control subject, and
a first control value of the vector distance metric between the individual profile data for the control subject and the individual profile data for the first control neighbor is less than a value of the vector distance metric between the individual profile data for the control subject and the individual profile data for any other individual of the first population;
determining, within the first population, a second control neighbor for the subject, wherein
the second control neighbor is different from the control subject and the first control neighbor, and
a second control value of the vector distance metric between the individual profile data for the first control neighbor and the individual profile data for the second control neighbor is less than a value of the vector distance metric between the individual profile data for the first control neighbor and the individual profile data for any other individual of the first population;
determining a deviation of the control subject from the first population based on a ratio of the first control value of the vector distance metric divided by the second control value of the vector distance metric;
determining for each other individual of the third plurality of individuals, a corresponding first control neighbor and a corresponding second control neighbor;
determining for each other individual of the third plurality of individuals, a corresponding first control value of the vector distance metric and a corresponding second control value of the vector distance metric;
determining for each other individual of the third plurality of individuals, a corresponding deviation from the first population based on a ratio of the corresponding first control value of the vector distance metric divided by the corresponding second control value of the vector distance metric;
determining for the third plurality of individuals, an average control deviation; and
determining whether the third population is different from the second population based on a difference between the average deviation and the average control deviation.

10. A method as recited in claim 9, wherein the first population comprises a plurality of untreated individuals with a first condition, the second population comprises a plurality of individuals with the first condition who have been treated using a first treatment, and the third population comprises a plurality of individuals with the first condition who have been treated using a different second treatment.

11. A method as recited in claim 1, wherein:
each of the first population and the second population is a population of biological cells; and,
each parameter of the plurality of parameters represents expression of a corresponding function or molecule type by an individual cell of the corresponding population of biological cells or expressed in bulk by the corresponding population of biological cells.

12. A method as recited in claim 2, wherein:
each of the first population and the second population is a population of biological cells;
each parameter of the plurality of parameters represents expression of a corresponding function or molecule type by an individual cell of the corresponding population of biological cells or expressed in bulk by the corresponding population of biological cells; and,
the weight specific to each parameter is based on a GeneCards Inferred Functionality Score (GIFtS) for the corresponding function or molecule, or based on a number of interacting partners for the corresponding function or molecule, or based on some combination.

13. A method as recited in claim 1, wherein the first population comprises a plurality of individuals in a first social network group, and the second population comprises a plurality of individuals in a different second social network group.

14. A method as recited in claim 2, wherein:
the method further comprises determining a plurality of principal components of the individual profile data for the first population or the second population; and
the weight specific to each parameter is based on a magnitude for that parameter in a selected principal component of the plurality of principal components.

15. A method as recited in claim 14, wherein the selected principal component is a principal component that accounts for most of the variance in the first population or the second population

16. A method as recited in claim 1, wherein the second population is a subset of the first population.

17. A method as recited in claim 1, further comprising operating on a member of the second population based on the result.

18. A non-transitory computer-readable medium carrying one or more sequences of instructions, wherein execution of the one or more sequences of instructions by one or more processors causes an apparatus to perform the steps of:
retrieving first population data comprising individual profile data for each individual in the first population comprising a first plurality of individuals, wherein the individual profile data indicates values for each parameter of a plurality of parameters;
determining the individual profile data for a subject drawn from a second population comprising a second plurality of individuals;
determining, within the first population, a first neighbor for the subject, wherein the first neighbor is different from the subject, and
a first value of a vector distance metric between the individual profile data for the subject and the individual profile data for the first neighbor is less than a value of the vector distance metric between the individual profile data for the subject and the individual profile data for any other individual of the first population;
determining, within the first population, a second neighbor for the subject, wherein
the second neighbor is different from the subject and the first neighbor, and
a second value of the vector distance metric between the individual profile data for the first neighbor and the individual profile data for the second neighbor is less than a value of the vector distance metric between the individual profile data for the first neighbor and the individual profile data for any other individual of the first population;
determining a deviation of the subject from the first population based on a ratio of the first value of the vector distance metric divided by the second value of the vector distance metric; and
presenting on a display device a result based on the deviation.

19. A system comprising:
at least one processor; and
at least one memory including one or more sequences of instructions,
the at least one memory and the one or more sequences of instructions configured to, with the at least one processor, cause at least one apparatus to perform at least the following,
obtain first population data comprising individual profile data for each individual in the first population comprising a first plurality of individuals, wherein the individual profile data indicates values for each parameter of a plurality of parameters;
determine the individual profile data for a subject drawn from a second population comprising a second plurality of individuals;
determine, within the first population, a first neighbor for the subject, wherein the first neighbor is different from the subject, and
a first value of a vector distance metric between the individual profile data for the subject and the individual profile data for the first neighbor is less than a value of the vector distance metric between the individual profile data for the subject and the individual profile data for any other individual of the first population;
determine within the first population, a second neighbor for the subject, wherein the second neighbor is different from the subject and the first neighbor, and
a second value of the vector distance metric between the individual profile data for the first neighbor and the individual profile data for the second neighbor is less than a value of the vector distance metric between the individual profile data for the first neighbor and the individual profile data for any other individual of the first population;
determine a deviation of the subject from the first population based on a ratio of the first value of the vector distance metric divided by the second value of the vector distance metric; and
present on a display device a result based on the deviation.
